(19) United States
(12) Patent Application Publication
(10) Pub. No.: US 2007/0261059 A1
(43) Pub. Date: Nov. 8, 2007

(54) Array-based memory abstraction

(76) Inventors: Joseph F. Orth, Ft. Collins, CO (US); Erin A. Handgen, Ft. Collins, CO (US); Leith L. Johnson, Ft. Collins, CO (US); Jonathan P. Lotz, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/410,398

(22) Filed: Apr. 25, 2006

(51) Int. Cl. G06F 9/46

(52) U.S. Cl. 719/312

(57) ABSTRACT

Array based memory abstraction in a multiprocessor computing system is disclosed. A plurality of memory resources are operably connected to an interconnect fabric. In a plurality of memory blocks, each memory block represents a contiguous portion of the plurality of memory resources. A cell is operably connected to the interconnect fabric. The cell has an agent with a fabric abstraction block, and the fabric abstraction block includes a block table having an entry for each of the plurality of memory blocks. A memory controller is associated with the agent, is operably connected to the interconnect fabric, and is configured to control a portion of the plurality of memory blocks.

### BACKGROUND

A modern computer system architecture is generally able to support many processors and memory controllers. A central processing unit (CPU) and its associated chipset generally include a limited amount of fast on-chip memory resources. A far larger amount of memory is addressable by the CPU, but is physically separated from the CPU by an interconnect fabric. Interconnect fabrics include network infrastructure for connecting system resources such as chips, cells, memory controllers, and the like. Interconnect fabrics may, for example, include switches, routers, backplanes, and/or crossbars. In a further illustrative example, an interconnect fabric may comprise an InfiniBand system having host-channel adapters in servers, target-channel adapters in memory systems or gateways, and connecting hardware (e.g., switches using Fibre Channel and/or Ethernet connections).

In such an architecture, abstraction layers are used to hide low-level implementation details. In a shared memory system, using a single address space or shared memory abstraction, each processor can access any data item without a programmer having to worry about the physical location of the data, or how to obtain its value from a hardware component. This frees the programmer to focus on program development rather than on managing partitioned data sets and communicating values.

Physical memory resources (e.g., DRAM memory and other memory devices) are mapped to a specific location in a physical address space. Generally, low-level addressing information for all of the physical memory resources available to the system is hidden or otherwise abstracted from the operating system. If the hardware does not abstract all of memory, then system resource allocation and reallocation (e.g., adding and removing physical resources, and replacing failing physical resources) becomes very difficult, as any unabstracted memory would simply be reported directly to an operating system. Operating systems typically lack substantial support for online configuration of physical resources.

In a server chipset, especially in high-end server chipset architectures, prior solutions for mapping, allocation, and interleaving of physical memory resources have involved the use of content-addressable memory (CAM) based structures with a backing store. Such structures basically comprise several comparators (i.e., comparison circuits) that operate in parallel. When one of these comparison circuits matches the input, its output signal goes high. This signal then sensitizes a corresponding line in the backing store. Additional bits from the incoming address are used to determine the final data.

CAMs are not able to represent memory either as interleaved or as uninterleaved with equal ease. In addition, CAM-based memory allocation restricts the number of interleaving regions that the hardware can support by providing a pre-defined and relatively small number of entries. In a typical example, a CAM-based memory allocation system would implement 16 CAMs, which means that the system would only be able to be set up with 16 different interleave regions. Sixteen regions may normally be enough for systems in which the memory is evenly loaded; however, when a system operator adds more memory to a single memory controller, the memory becomes unevenly loaded. Where there is unevenly loaded memory, the system often will not be able to map all of the memory in the system through the CAMs, as each non-uniform group requires the use of an interleave region, and the number of interleave regions is limited by hardware constraints.

### BRIEF DESCRIPTION OF THE DRAWINGS

For the purpose of illustrating the invention, there is shown in the drawings a form that is presently exemplary; it being understood, however, that this invention is not limited to the precise arrangements and instrumentalities shown.

FIG. 1 is a block diagram depicting exemplary memory organization in a multiprocessor computing system according to an embodiment of the invention.

FIG. 2 is a diagram depicting exemplary address translations in a multiprocessor computing system for practicing an embodiment of the invention.

FIG. 3 is a diagram depicting exemplary address translations in a multiprocessor computing system for practicing a further embodiment of the invention.

FIG. 4A is a diagram illustrating a block table for practicing an embodiment of the invention.

FIG. 4B is a diagram depicting an illustrative entry in a block table for practicing an embodiment of the invention.

FIG. 5A is a diagram illustrating an interleave table for practicing an embodiment of the invention.

FIG. 5B is a diagram depicting an illustrative entry in an interleave table for practicing an embodiment of the invention.

FIG. 6 is a diagram depicting interleaving in a fabric abstraction block according to an embodiment of the invention.

FIG. 7 is a flow chart of an exemplary method for array-based memory abstraction according to an embodiment of the present invention.

### DETAILED DESCRIPTION

Overview

Aspects of the present invention provide memory abstraction using arrays, allowing for flexibility in the memory subsystem of high-end computer server chipsets, especially when compared to CAM-based implementations. In some embodiments, these arrays are latch arrays; in other embodiments, the arrays may be implemented using Static Random Access Memory (SRAM). Using an embodiment of the present invention, an exemplary chipset using latch arrays having 4,096 entries may be expected to achieve a level of flexibility in memory allocation that would generally require more than one thousand CAM entries in a conventional CAM-based system. At that size, the CAM-based solution would pose a larger power constraint and area constraint on a chipset than would the use of latch arrays according to embodiments of the present invention.

In an embodiment of the invention, the array represents a linear map of the address space of the system. This means that the lowest order entry in the array (e.g., entry zero) represents the lowest order addresses. Conversely, the highest order entry in the array represents highest addresses in the space to be mapped. The address space is broken up into a number of discrete chunks corresponding to the number of entries contained in the array. This allows for a certain number of high order address bits to be used as the index for lookup operations in the arrays.

In some embodiments, an agent is provided to perform array lookups and related operations. For example, the input to the agent can be an address (such as a physical address or an operating system address), and the output of the agent is a fabric address that can, for example, represent a physical node identifier for the location where the memory resource is stored.

Embodiments of array-based memory abstraction have the ability to map all memory resources available to the system. The ability to map all of memory comes into play when dealing with online component modifications, such as adding, replacing and or deleting components. Such online component modifications provide the ability to extend the uptime of a partition, and can also provide the ability to augment and/or redistribute resources throughout the system from partitions that do not need the resources to partitions that do.

Some embodiments of array-based memory abstraction also have the advantage of being able to map interleaved and uninterleaved memory with equal ease. Further aspects of the present invention allow a greater number of interleaving regions than typical CAM-based solutions, as well as the ability to map all of memory, even in the event of uneven loading. Embodiments of array-based memory abstraction are able to handle uneven loading by providing the ability to add an interleave group for a memory region that is non-uniform, whereas a CAM-based solution would require the use of one of a limited number of entries.

Illustrative Computing Environment

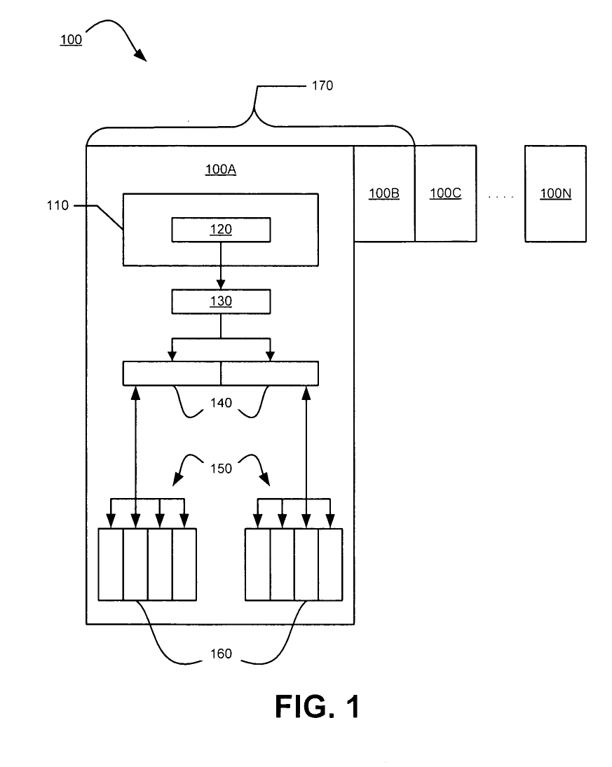

Referring to the drawings, in which like reference numerals indicate like elements, FIG. 1 depicts exemplary memory organization in a multiprocessor computing system 100 according to an embodiment of the invention, in which the herein described apparatus and methods may be employed. The multiprocessor computing system 100 has a plurality of cells 100A . . . 100N. For illustrative purposes, cell 100A is depicted in greater detail than cells 100B . . . 100N, each of which may be functionally similar to cell 100A or substantially identical to cell 100A.

In an exemplary embodiment, the system 100 is able to run multiple instances of an operating system by defining multiple partitions, which may be managed and reconfigured through software. In such embodiments, a partition includes one or more of the cells 100A . . . 100N, which are assigned to the partition, are used exclusively by the partition, and are not used by any other partitions in the system 100. Each partition establishes a subset of the hardware resources of system 100 that are to be used as a system environment for booting a single instance of the operating system. Accordingly, all processors, memory resources, and I/O in a partition are available exclusively to the software running in the partition. Generally, partitions can be reconfigured to include more, fewer, and/or different hardware resources, but doing so requires shutting down the operating system running in the partition, and resetting the partition as part of reconfiguring it.

An exemplary partition 170 is shown in the illustrated embodiment. The exemplary partition 170 comprises cell 100A and cell 100B. Each of the cells 100A . . . 100N can be assigned to one and only one partition; accordingly, further exemplary partitions (not shown) may be defined to include any of the cells 100C . . . 100N. In the illustrated embodiment, exemplary partition 170 includes at least one CPU socket 110 and at least one memory controller 140; however, in other embodiments, CPU socket 110 and/or memory controller 140 may be subdivided into finer granularity partitions.

In an illustrative example of a multiprocessor computing system 100 having a plurality of cells 100A . . . 100N, one or more cell boards can be provided. Each cell board can include a cell controller and a plurality of CPU sockets 110. In the exemplary embodiment, each one of the cells 100A . . . 100N is associated with one CPU socket 110. Each CPU socket 110 can be equipped with a CPU module (e.g., a single-processor module, a dual-processor module, or any type of multiple-processor module) for equipping the system 100 with a plurality of CPUs such as exemplary CPU 120.

Each of the CPU sockets 110, in the exemplary embodiment, has one or more agents 130. Agent 130, in the exemplary embodiment, is associated with two memory controllers 140; however, in other embodiments, agent 130 may be designed to support any desired number of memory controllers 140. Agent 130 may, for example, be a logic block implemented in a chipset for the system 100. In an exemplary embodiment, agent 130 includes a fabric abstraction block (FAB) for performing tasks such as address map implementation, and memory interleaving and allocation. In further embodiments, agent 130 may perform additional tasks.

Each memory controller 140 is able to support physical memory resources 150 that include one or more memory modules or banks, which may be and/or may include one or more conventional or commercially available dynamic random access memory (DRAM), synchronous DRAM (SDRAM), double data rate SDRAM (DDR-SDRAM) or Rambus DRAM (RDRAM) memory devices, among other memory devices. For organizational purposes, these memory resources 150 are organized into blocks called memory blocks 160. Each memory controller 140 can support a plurality of memory blocks 160.

A memory block 160 is the smallest discrete chunk or portion of contiguous memory upon which the chipset of system 100 can perform block operations (e.g., migrating, interleaving, adding, deleting, or the like). A memory block 160 is an abstraction that may be used in the hardware architecture of the system 100.

In some embodiments, all of the memory blocks 160 in the system 100 have a fixed and uniform memory block size. For example, in one illustrative embodiment, the memory block size is one gigabyte (2³⁰ bytes) for all memory blocks 160. In other typical illustrative embodiments, a memory block size can be 512 megabytes (2²⁹ bytes) for all memory blocks 160, two gigabytes (2³¹ bytes) for all memory blocks 160, four gigabytes (2³² bytes) for all memory blocks 160, eight gigabytes (2³³ bytes) for all memory blocks 160, or sixteen gigabytes (2³⁴ bytes) for all memory blocks 160. In further embodiments, the size of a memory block 160 may be larger or smaller than the foregoing illustrative examples, but for all memory blocks 160, the memory block size will be a number of bytes corresponding to a power of two.

For example, in one illustrative embodiment, a memory controller 140 can support a maximum of thirty-two memory blocks 160. In an illustrative implementation having memory blocks 160 that are eight gigabytes in size, the exemplary memory controller 140 is able to support memory resources 150 comprising up to four Dual Inline Memory Modules (DIMMs) each holding sixty-four gigabytes. In other embodiments, the memory controller 140 can support a larger or smaller maximum number of memory blocks 160.

In still further embodiments, the system 100 can support memory blocks 160 that are variable (i.e., non-uniform) in memory block size; for example, such an implementation of system 100 may include a first memory block 160 having a memory block size of one gigabyte, and a second memory block 160 having a memory block size of sixteen gigabytes. In such embodiments, the size of a memory block 160 may be defined at the level of the memory controller 140 to whatever size is appropriate for the memory resources 150 that are controlled by memory controller 140. In such embodiments, the memory block size is uniform for all of the memory blocks 160 that are controlled by memory controller 140. In further embodiments, the memory block size is uniform for all of the memory blocks 160 in a partition 170.

It is appreciated that the exemplary computer system 100 is merely illustrative of a computing environment in which the herein described systems and methods may operate and does not limit the implementation of the herein described systems and methods in computing environments having differing components and configurations, as the inventive concepts described herein may be implemented in various computing environments having various components and configurations.

Illustrative Address Translations

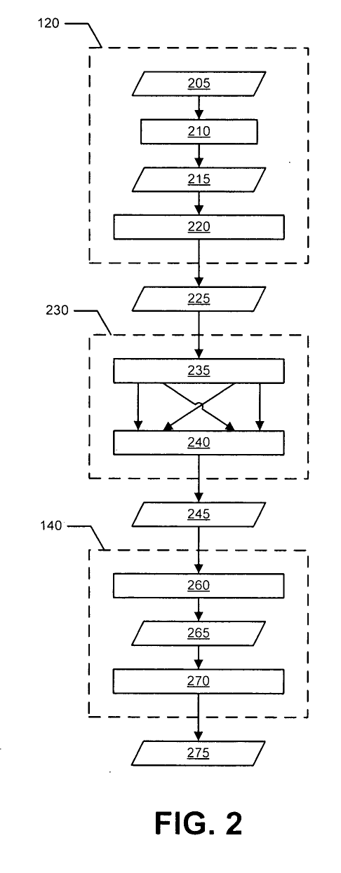

FIG. 2 depicts exemplary address translations in a multiprocessor computing system 100 in accordance with one embodiment.

In a computer system architecture using aspects of the present invention, multiple address space domains exist for memory resources 150. For example, an application may address memory resources 150 using a virtual address (VA) 205 in a virtual address space, and an operating system (OS) or a partition 170 may address memory resources 150 using a physical address (PA) 215 in a physical address space.

Applications running on CPU 120 are able to use a virtual address 205 for a memory resource 150 controlled by memory controller 140. The virtual address 205 is converted by the CPU 120 to a physical address 215. In the illustrated embodiment, a translation lookaside buffer (TLB) 210 can perform the virtual-to-physical address translation, such as by using techniques that are known in the art.

In some embodiments, a switch, router, or crossbar (such as a processor crossbar in a multiprocessor architecture) may address memory resources 150 using a system address 225 in a system address space. In such implementations, logic can be provided (e.g., in a source decoder 220) to convert the physical address 215 to a system address 225. Source decoder 220 is associated with a source of transactions, such as CPU 120, CPU socket 110, or one of the cells 100A . . . 100N.

In an embodiment of the invention, an illustrative example of a system address 225 is a concatenation of a system module identifier (SMID) and the physical address 215. In an exemplary system address space, every valid address is associated with an amount of actual memory (e.g., DRAM memory), and the system address space is sufficient to contain all of the physical address spaces that may be present in a system.

A fabric abstraction block (FAB) 230 is provided for implementation of a fabric address space that can support a plurality of independent system address spaces and maintain independence between them. An exemplary FAB 230 may be included or implemented on a chipset, such as in agent 130.

The FAB 230 may, for example, comprise one or more logic blocks (e.g., an address gasket) for translating the system address 225 to a fabric address 245, and vice versa, such as by using reversible modifications to the addresses 225, 245. In an embodiment of the invention, an illustrative example of a fabric address 245 is a concatenation of a fabric module identifier (FMID) and the physical address 215. In some implementations, the translation between system address 225 and fabric address 245 may involve masking a partition identifier (such as the SMID, FMID, or a partition number) with an appropriate masking operation.

The FAB 130 is able to use one or more arrays to abstract the locations of memory resources 150 from the operating systems that reference such resources. In one embodiment of the invention, FAB 230 includes a block table 240, e.g., a physical block table (PBT). Block table 240 is a lookup table that can be implemented as a latch array (e.g., using SRAM) having a plurality of entries.

In a further embodiment of the invention, FAB 230 includes two tables which can be implemented as latch arrays: an interleave table (ILT) 235, and a block table 240. Block table 240 will generally have the same number of entries as the ILT 235. In the illustrative embodiments, both the ILT 235 and block table 240 are arrays that are indexed with a portion of the fabric address 245, thus negating any need for the use of content-addressable memory in the FAB 230. For example, in an implementation where the fabric address 245 includes a 12-bit FMID, the ILT 235 and block table 240 each have 2¹² entries (i.e., 4,096 entries).

The fabric address 245 provided by the FAB 230 may be passed through the interconnect fabric to a memory controller 140. In an embodiment, the FMID portion of fabric address 245 identifies the destination memory controller 140, and may be used in forming a packet header for a transaction.

An exemplary memory controller 140 may include coherency controller functionality. For example, in the illustrated embodiment, memory controller 140 includes content-addressable memory such as memory target CAM (MTC) 260 for deriving a memory address 265 from the fabric address 245. In some embodiments, one MTC 260 is associated with one memory block 160.

In an illustrative example, a portion of the fabric address 245 may be matched against the MTC 260, and a resulting memory address 265 may be passed to a DRAM memory address converter in the memory controller 140. The exemplary memory controller 140 is able to use a memory block allocation table (MBAT) 270 to look up memory address 265 and provide a DIMM address (DA) 275. DA 275 identifies the desired location (e.g., rank, bank, row, column) of the memory resource 150 corresponding to the virtual address 205.

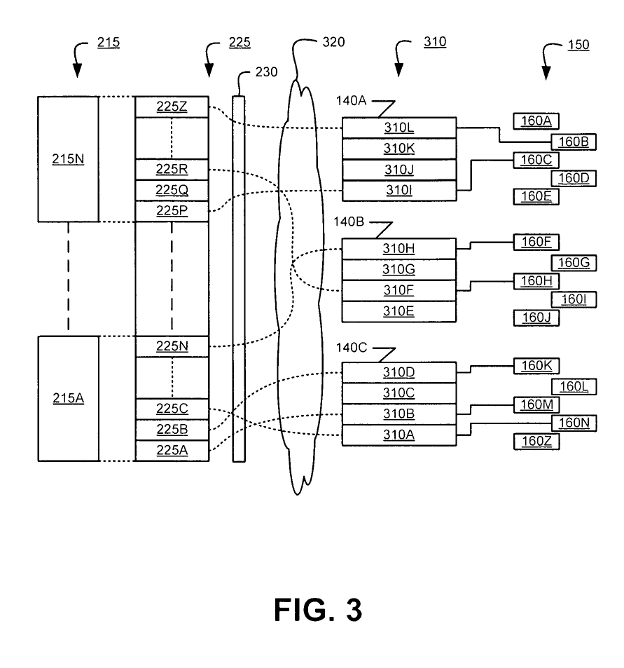

FIG. 3 is a diagram illustrating exemplary address translations in a further embodiment of a multiprocessor computing system 100 in accordance with an embodiment.

An address such as physical address 215 is represented by a number; for example, in some implementations, physical address 215 is a 50-bit number having a range of possible values from zero to 2⁵⁰−1. Accordingly, the physical address 215 exists in an address space, encompassing the range of values of the physical address 215, that can be fragmented into multiple physical address spaces (e.g., regions or slices), such as physical address spaces 215A . . . 215N. Exemplary physical address spaces 215A . . . 215N are each self-contained and co-existing separately from each other. Any interaction between the separate physical address spaces 215A . . . 215N is considered an error. For example, one of the physical address spaces 215A . . . 215N may be used to address one hardware resource, such as a memory resource 150 or a memory module. In some cases, a physical address 215 or one of the physical address spaces 215A . . . 215N may be reserved but not associated with actual memory or resources in the system 100.

A system address 225 is represented by a number; for example, in some implementations, system address 225 is a 62-bit number having a range of possible values from zero to 2⁶²−1. Accordingly, the system address 225 exists in an address space, encompassing the range of values of the system address 225. The system 100 has one shared system address space 225A . . . 225Z, which is able to represent multiple physical address spaces 215A . . . 215N.

A system address slice is a portion of the system address space 225A . . . 225Z that is claimed for a corresponding resource, such as a remote memory resource 150. Each system address slice is able to represent location information for the corresponding resource, such that transactions (e.g., accesses, read/write operations, and the like) can be sent to the corresponding resource. One system address region is able to represent an equally-sized one of the physical address spaces 215A . . . 215N. In the illustrated example, a first system address region comprising slices 225A . . . 225N represents an equally-sized physical address space 215A, and a second system address region comprising slices 225P . . . 225Z represents an equally-sized physical address space 215N.

System address 225 is translated to fabric address 245 by FAB 230. Transactions may be routed through interconnect fabric 320 (depicted in simplified form as a network cloud) to a corresponding resource such as a memory controller 140. In the illustrated example, each of the memory controllers 140A . . . 140C includes content-addressable memory such as CAM 310A . . . 310L (collectively, target CAMs 310). Each of the target CAMs 310 is programmed to accept addresses (such as fabric address 245 or a portion thereof) that are sent by a corresponding one of the system address slices 225A . . . 225Z. In an illustrative embodiment, once the address is claimed using the target CAMs 310, the address can be used by the associated memory controller to service the corresponding memory resource 150, such as by performing the desired transaction in one of the memory blocks 160A . . . 160Z that corresponds to the desired physical address 215.

Exemplary Data Elements

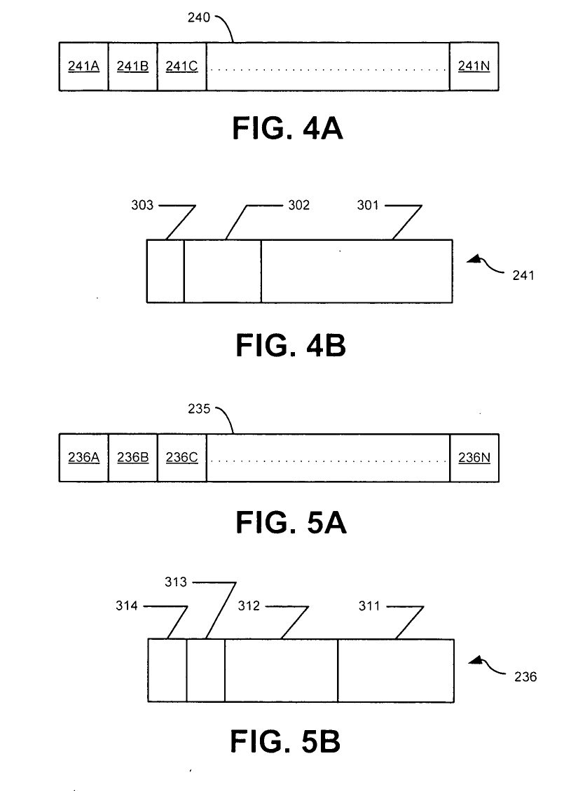

FIG. 4A is a diagram illustrating a block table 240 for practicing an embodiment of the invention. Block table 240 comprises a plurality of block entries 241A . . . 241N (each a block table entry 241). In an embodiment, the number of block entries 241 is equal to the number of memory blocks 160 supported by the system 100.

Embodiments of the array-based abstraction scheme divide up the memory resources 150 of system 100 into a number of discrete chunks known as memory blocks 160. At the point in time when the chipset architecture of system 100 is first introduced, the number of memory blocks 160 will be fixed; that is, the arrays of tables 235, 240 contain a fixed number of entries.

In some embodiments, the size of a memory block 160 is uniform across the entire system 100. This implies that each of the entries in tables 235, 240 represents a fixed amount of memory. In such embodiments, the maximum total amount of memory resources 150 in the system is also fixed. However, commercially available densities for memory modules (e.g., DIMMs) generally tend to increase over time; in an illustrative example, the capacity of commercially available memory modules may double every two years. Therefore, as the architecture of system 100 matures, the arrays of tables 235, 240 may no longer allow for the capacities of memory resources 150 that are required of the system 100.

In other embodiments, the size of a memory block 160 is not uniform across the entire system 100. The use of variable-sized memory blocks 160 allows the size of the arrays 235, 240 to remain fixed (thus helping to control costs), as well as maintaining flexibility in memory allocation comparable to the flexibility existing at the time of introduction of the chipset architecture of system 100. In some embodiments using variable-sized memory blocks 160, all of the memory blocks 160 controlled by a memory controller 140 are uniform in size. In further embodiments using variable-sized memory blocks 160, all memory blocks 160 within a partition 170 are uniform in size.

An exemplary embodiment of array-based memory abstraction is able to use a portion, such as selected bits, of a system address 225 as an index into an array (e.g., either of tables 235, 240). In an illustrative embodiment, the FAB 230 determines which higher and/or lower order bits of the system address 225 to use as an index, e.g., based on the value of an agent interleave number 311 (shown in FIG. 5B below) in ILT 235. In a further illustrative embodiment, the block table 240 can be indexed by a system module ID (e.g., the first 12 bits of system address 225). In block table 240, the index selects a particular one of the block table entries 241A . . . 241N, and the selected block table entry 241 is able to contain sufficient information for the hardware of agent 130 to determine where the particular access should be directed. The number of bits used for determining this index is specific to a particular implementation of an embodiment. The more bits that are used, the more entries must be resident in the tables 235, 240, which implies that larger tables 235, 240 are needed. Since these tables 235, 240 are implemented as physical storage structures on a chip, the larger they are, the more expensive and slower they are. While tables 235, 240 that are relatively small may be able to map the entire amount of physical memory resources 150 that a system 100 can hold, the table size is inversely related to the granularity of the memory that is mapped. If the granularity is too large, a user may perceive this to be a problem reducing system flexibility.

There is also a trade-off to be made between the number of memory blocks 160 and the size of memory blocks 160. The trade-off makes it possible to tune the size and flexibility of access by the system 100 to the memory resources 150. As the chipset architecture matures, a memory block 160 will need to map a larger pool of memory resources 150, thus allowing user applications to make use of the extra capacity. The use of variable-sized memory blocks 160 can allow the arrays of tables 235, 240 to represent more memory while maintaining the same footprint on a chip. This means that the cost of the chip will not necessarily increase as the size of memory resources 150 increases over time.

FIG. 4B is a diagram depicting an illustrative block table entry 241 in a block table 240 for practicing an embodiment of the invention. An illustrative example of block table entry 241 comprises a cell identifier 301, an agent slice identifier 302, and a controller number 303. An example of a cell identifier 301 is an identifier for a cell or a cell board in system 100 associated with target memory resource 150. An example of agent slice identifier 302 is an identifier for an agent 130 associated with target memory resource 150 and the cell identifier 301. An example of controller number 303 is an identifier associated with a memory controller 140 or a coherency controller of the agent 130 for the memory resource 150. In some embodiments, block table entry 241 may include state information (such as a swap enable state) and/or other information.

FIG. 5A is a diagram illustrating an ILT 235 for practicing an embodiment of the invention. ILT 235 comprises a plurality of ILT entries 236A . . . 236N (each an ILT entry 236). In an embodiment, the ILT 235 is indexed by selected bits of the system address 225; for example, by a system module ID which may comprise the first 12 bits of system address 225. In a further embodiment, the ILT 235 may be indexed by a source module identifier found in a request from a CPU 120; the use of such an index may, for example, be useful for subdividing one of the cells 100A . . . 100N into multiple fine grained partitions.

FIG. 5B is a diagram depicting an illustrative ILT entry 236 in an ILT 235 for practicing an embodiment of the invention. An illustrative example of ILT entry 236 comprises an agent interleave number 311, a partition ownership identifier 312, a sharing bit 313, a validity bit 314. An example of an agent interleave number 311 is an identifier for a degree of interleaving for the memory block 160 associated with the ILT entry 236. A suitable exemplary set of agent interleave numbers 311, using three bits (i.e., values from 0 to 7) in ILT entry 236, is shown in Table 1 below:

TABLE 1

| Number | Description |
|---|---|
| 0 | Uninterleaved |
| 1 | 2-way interleaved |
| 2 | 4-way interleaved |
| 3 | 8-way interleaved |
| 4 | 16-way interleaved |
| 5 | 32-way interleaved |
| 6 | 64-way interleaved |
| 7 | 128-way interleaved |

An example of a partition ownership identifier 312 is a number (e.g., a three-bit vector) that denotes a partition 170 (e.g., an operating system partition) that owns the memory block 160 associated with the ILT entry 236. In some embodiments supporting variable sizes of memory block 160, the size of the memory block 160 will be uniform within each partition. Accordingly, in such embodiments, the partition ownership identifier 312 may be used (e.g., by the agent 130 or FAB 230) to look up the size of the memory block 160 associated with the ILT entry 236.

An example of a sharing bit 313 is a bit whose value identifies whether the memory block 160 associated with the ILT entry 236 participates in global shared memory communications. An example of a validity bit 314 is a bit whose value identifies whether the current ILT entry 236 is valid.

Interleaving

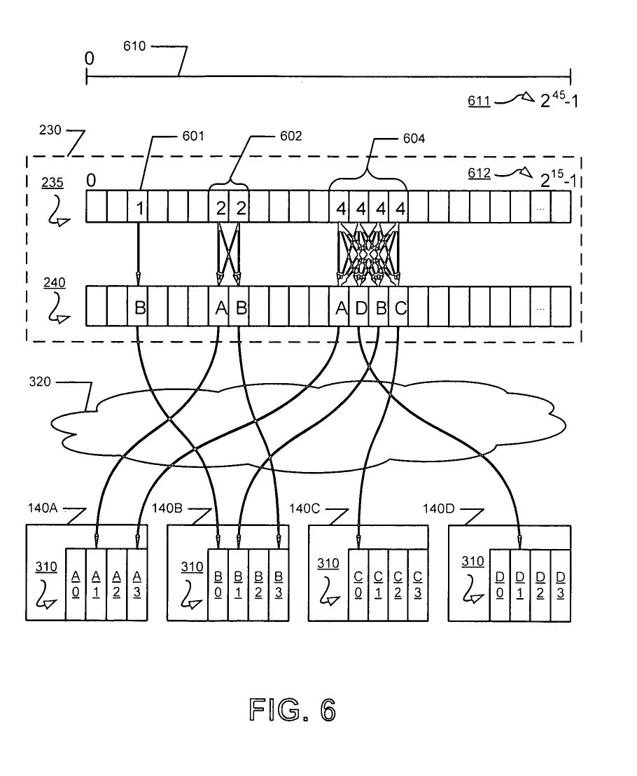

FIG. 6 is a diagram depicting interleaving in a fabric abstraction block 230 according to an embodiment of the invention.

A physical address scale 610 is shown in relation to the ILT table 235 and block table 240. In an exemplary embodiment, the value of a physical address 215 can range from zero to a maximum value 611, which in the illustrated embodiment is 2⁴⁵−1. In the exemplary embodiment, there is a fixed number of entries in the ILT table 235 and the block table 240, and the index for an entry can range from zero to a maximum value 612, which in the illustrated embodiment is 2¹⁵−1.

The ILT 235 and block table 240 can be configured to perform interleaving on an interleaved region of memory resources 150 accessed through target CAMs 310. In the illustrated example, each of the memory controllers 140A . . . 140D includes target CAMs 310. For clarity of illustration, exemplary target CAMs 310 corresponding to four memory blocks 160 are shown for each of the memory controllers 140A . . . 140D. However, in some embodiments, any number of target CAMs 310 may be present in memory controllers 140A . . . 140D. In the illustration, target CAMs 310 of memory controller 140A are labeled A0 . . . A3, target CAMs 310 of memory controller 140B are labeled B0 . . . B3, target CAMs 310 of memory controller 140C are labeled C0 . . . C3, and target CAMs 310 of memory controller 140D are labeled D0 . . . D3.

In embodiments of the invention, the number of ILT entries 236 and block table entries 241 used for an interleaved region are equal to the number of ways of interleaving. A non-interleaved region 601 for one memory block 160 requires one dedicated ILT entry 236 in ILT table 235, and one dedicated block table entry 241 in block table 240. As illustrated, a two way interleave group 602 for two memory blocks 160 is implemented using two dedicated ILT entries 236 in ILT table 235, and two dedicated block table entries 241 in block table 240. As further illustrated, a four way interleave group 604 for four memory blocks 160 is implemented using four dedicated ILT entries 236 in ILT table 235, and four dedicated block table entries 241 in block table 240. Similarly, eight entries 236, 241 in each of the tables 235, 240 would be dedicated to an eight way interleave group, and so forth. This technique allows the FAB 230 to implement interleaves from two-way interleaving, all the way up to interleaving by the number of ways corresponding to the number of ILT entries 236 in the ILT 235. This is generally more flexible, and in some embodiments will yield a more efficient use of resources, than a typical CAM-based implementation.

To do this interleaving, ILT entries 236 and block table entries 241 are used in pairs and accessed sequentially. The first array that is accessed is the ILT 235, which contains interleaving information. The address is reformatted based on this information, and a new index is generated (based on the incoming address and the interleaving information). This new index is used to access the block table 240 and look up the corresponding block table entry 241. The block table entry 241 can be used to produce a destination node identifier.

Exemplary Method

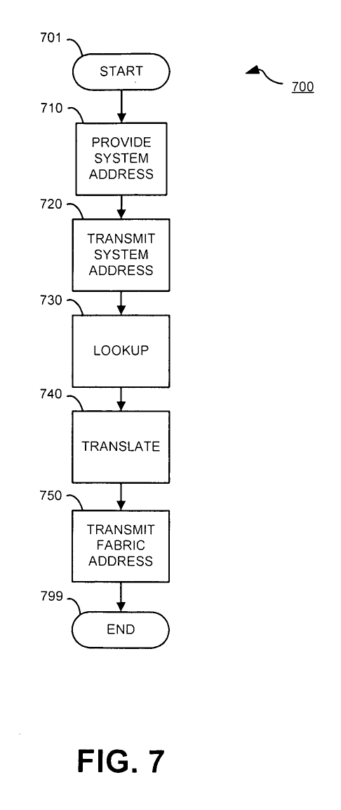

FIG. 7 is a flow chart of an exemplary method 700 for array-based memory abstraction according to an embodiment of the present invention.

The method 700 begins at start block 701, and proceeds to block 710. At block 710, a system address 225 is provided for a desired memory block. For example, TLB 210 can translate virtual address 205 to physical address 215. In some embodiments, the CPU 120 or source decoder 220 is able to derive the system address 225 from the physical address 215.

At block 720, the system address 225 is transmitted to a fabric abstraction block such as FAB 230. In some embodiments, the source decoder 220 or the CPU 120 can transmit the system address 225 to an agent 130 that includes the FAB 230.

At block 730, the system address 225 is looked up in a table. In some implementations, the table is block table 240; for example, the FAB 230 performs a lookup by using a portion of the system address 225 as an index into block table 240.

In other implementations, the table is interleave table 235; for example, the FAB 230 performs a lookup by using a portion of the system address 225 as an index into interleave table 235. The FAB 230 is then able to generate an index into the block table 240, based on the system address 225 and an interleave table entry 236 of the interleave table 235. The FAB 230 then accesses the block table 240 using the index.

At block 740, the system address 225 is translated to a fabric address 245. In an embodiment of the invention, an illustrative example of a fabric address 245 is a concatenation of a FMID and the physical address 215. In some implementations, the translation between system address 225 and fabric address 245 may involve masking a partition identifier (such as the SMID, FMID, or a partition number) with an appropriate masking operation.

At block 750, the fabric address 245 is transmitted to a destination memory controller 140. For example, the FAB 230 or the agent 130 may transmit the fabric address 245 over interconnect fabric 320. The destination memory controller 140 can then use a portion of the fabric address 245 (such as a FMID) to identify a destination target CAM 310 associated with the destination memory controller 140. The controller 140, in some embodiments, matches the portion of the fabric address 245 against the destination target CAM 310. The portion of the fabric address 245 is then passed to a memory address converter (such as a portion of the controller 140 able to perform lookups in MBAT 270) that is able to convert the portion of the fabric address 245 to a memory resource address (e.g., DIMM address 275) corresponding to a memory resource 150. A desired operation or transaction may then be performed on the desired memory resource 150 or desired memory block 160. The method 700 concludes at block 799.

Although exemplary implementations of the invention have been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A system for array based memory abstraction in a multiprocessor computing system, comprising:
a plurality of memory resources operably connected to an interconnect fabric,
a plurality of memory blocks, each memory block representing a contiguous portion of the plurality of memory resources,
a cell operably connected to the interconnect fabric, and having an agent with a fabric abstraction block including a block table having an entry for each of the plurality of memory blocks, and
a memory controller associated with the agent, operably connected to the interconnect fabric, and configured to control a portion of the plurality of memory blocks.

2. The system of claim 1 wherein all memory blocks are uniform in size.

3. The system of claim 1 wherein
the system has a memory block size that is non-uniform, and
the memory controller has a memory block size that is uniform for the portion of the plurality of memory blocks

4. The system of claim 1 wherein
the system has a memory block size that is non-uniform,
the cell is assigned to a partition comprising one or more cells, and
the partition has a memory block size that is uniform.

5. The system of claim 1 wherein the block table comprises a latch array.

6. The system of claim 1 wherein the fabric abstraction block further comprises an interleave table having an entry for each of the plurality of memory blocks.

7. The system of claim 6 wherein the interleave table comprises a latch array.

8. The system of claim 1 wherein the block table is indexed with a portion of a fabric address.

9. The system of claim 1 wherein an index into the block table identifies the memory controller configured to control a desired memory block.

10. A method for array based memory abstraction in a multiprocessor computing system, comprising:
providing a system address for a desired memory block,
transmitting the system address to a fabric abstraction block,
looking up the system address in a table,
translating the system address to a fabric address using a result of the looking up, and
transmitting the fabric address to a destination memory controller.

11. The method of claim 10 wherein the table is a block table.

12 The method of claim 10 wherein the table is an interleave table, further comprising:
generating an index based on the system address and an interleave table entry of the interleave table, and
accessing a block table using the index.

13. The method of claim 10 further comprising
deriving the system address from a physical address.

14. The method of claim 10 further comprising
using a portion of the fabric address to identify a destination target content-addressable memory associated with the destination memory controller, and
matching the portion of the fabric address against the destination target content-addressable memory.

15. The method of claim 14 further comprising:
passing the portion of the fabric address to a memory address converter;
converting the portion of the fabric address to a memory resource address corresponding to a memory resource; and
performing an operation on the memory resource.

16. The method of claim 10 further comprising
performing an operation on the desired memory block.

17. A system for array based memory abstraction in a multiprocessor computing system, comprising:
a plurality of memory resources operably connected to an interconnect fabric,
a plurality of memory blocks, each memory block representing a contiguous portion of the plurality of memory resources,
a decoder for associating a system address with a desired memory block,
fabric abstraction means for translating the system address to a fabric address using a block table, and
a controller for receiving the fabric address and performing an operation on the desired memory block.
